(19) United States
(12) Patent Application Publication
(10) Pub. No.: US 2004/0014422 A1
(43) Pub. Date: Jan. 22, 2004

(54) Method and system for handovers using service description data

(75) Inventor: Janne J. Kallio, Ylojarvi (FI)

Correspondence Address: Morgan & Finnegan, L.L.P., 345 Park Avenue, New York, NY, 10154-0053, US

(73) Assignee: NOKIA CORPORATION, Espoo (FI)

(21) Appl. No.: 10/198,153

(22) Filed: Jul. 19, 2002

(51) Int. Cl. H04Q 7/20

(52) U.S. Cl. 455/41.1; 455/41.2; 455/422.1

(57) ABSTRACT

Terminal devices efficiently transition from a first access point to a second access point based on service discovery information that is transmitted by the second access point. In Bluetooth implementations, the present invention advantageously may be implemented without requiring modifications to a terminal device's terminal module. Accordingly, in handing over a wireless communications session from a first access point to a second access point, a terminal device establishes a link with the second access point. The terminal device receives service description data, such as an SDP message, from the second access point, selects a group key based on the service, and authenticates the link with the second access point using the selected group key.

### FIELD OF THE INVENTION

The present invention relates to wireless communications. More particularly, the present invention relates to handover techniques in a wireless communications network.

### BACKGROUND OF THE INVENTION

Short range wireless systems typically involve devices that have a communications range of one hundred meters or less. To provide communications over long distances, these short range systems often interface with other networks. For example, short range networks may interface with cellular networks, wireline telecommunications networks, and the Internet.

Wireless personal area networks (PANs) and wireless local area networks (LANs) are each types of short range wireless systems. PANs and WLANs typically have the common feature of operating in unlicensed portions of the radio spectrum, usually either in the 2.4 GHz Industrial, Scientific, and Medical (ISM) band or the 5 GHz Unlicensed-National Information Infrastructure (U-NII) band. Examples of wireless local area network technology include the IEEE 802.11 WLAN Standard and the HiperLAN Standard. A well known example of wireless personal area network technology is the Bluetooth Standard.

Bluetooth defines a short-range radio network, originally intended as a cable replacement. It can be used to create ad hoc networks of up to eight devices, where one device is referred to as a master device. The other devices are referred to as slave devices. The slave devices can communicate with the master device and with each other via the master device. The Bluetooth Special Interest Group, Specification Of The Bluetooth System, Volumes 1 and 2, Core and Profiles: Version 1.1, Feb. 22, 2001, describes the principles of Bluetooth device operation and communication protocols. This document is incorporated herein by reference in its entirety. The devices operate in the 2.4 GHz radio band reserved for general use by Industrial, Scientific, and Medical (ISM) applications. Bluetooth devices are designed to find other Bluetooth devices within their communications range and to discover what services they offer.

In many communications applications, portable terminal devices communicate with one or more fixed access points. Often, such portable terminal devices can pass in and out of the communications ranges of several access points during a single communications session. The maintenance of such a single communications session requires the terminal devices and access points to support what are known as handovers. During a handover, an existing communications link with a first access point is terminated, while a new communications link with a second access point is established.

Establishing a new link requires various processes to be performed. For example, in Bluetooth networks, devices perform a process known as paging. Paging establishes an unsecured connection between two devices (e.g., a terminal device and an access point). In addition, when certain security features are desired, terminal devices and access points perform a process known as authentication. Authentication is a process where two devices verify that they both have the same secret key. This secret key can then be used to effect security features, such as link encryption.

A successful authentication process requires that both devices share an encryption key. If this condition is not met, then a process known as pairing must also be performed. Pairing is a procedure where two devices exchange information, such as personal identification numbers (PINs) to establish a common secret key.

Fast handovers are desirable. Therefore, it is advantageous to minimize the latencies involved with each handover. Unfortunately, performance of both pairing and authentication is time consuming. In addition, the combination of these processes places large demands on network bandwidth, as well as on terminal device and access point processing capacity.

In order to solve some problems associated with handovers, the Bluetooth Special Interest Group (“the Bluetooth SIG”) has defined a concept known as group keys (also called service access keys). According to this concept, a network of access points maintains a database that can store a terminal's common link key (i.e., its Group Key). These group keys are indexed by the unique address associated with each terminal device.

Each access point in the network can query a group key for a terminal from this database. Alternatively, access points in close proximity can exchange group keys during events such as handovers. The group key concept is attractive because it reduces the complexity involved in maintaining a key database because each terminal has only one link key.

Nevertheless, group keys do not alleviate problems associated with handovers. For instance, despite the existence of group keys, a terminal device cannot engage in authentication with a new access point, because the terminal device does not know the new access point's address. Therefore, both pairing and authentication must be performed.

Bluetooth provides a protocol, known as the Service Discovery Protocol (SDP). SDP enables terminals to identify services offered by an access point However, techniques for using SDP to provide for handovers has not been currently suggested. Accordingly, what is needed are techniques for making handovers more efficient.

### SUMMARY OF THE INVENTION

The present invention enables terminal devices to efficiently transition from a first access point to a second access point based on service discovery information that is transmitted by the second access point. In Bluetooth implementations, the present invention advantageously may be implemented without requiring modifications to a terminal device's terminal module.

Accordingly, the present invention is directed to techniques for making handovers more efficient. A method of the present invention involves a terminal device handing over a wireless communications session from a first access point to a second access point. The terminal device establishes a link with the second access point; receives service description data, such as an SDP message, from the second access point; selects a group key based on the service description data; and authenticates the link with the second access point using the selected group key. This method may also include the terminal device sending the second access point a request for service description data. This service description data may correspond to a zone that includes the second access point.

A further method of the present invention involves a current access point handing over a wireless communications session with a terminal device from a previous access point. The current access point establishes a link with the terminal device; sends service description data to the terminal device; and authenticates the link with the second access point using a group key based on the service description data. The service description data may correspond to a zone that includes the current access point. This method may also include the current access point receiving a handover notification from the previous access point.

In yet a further method of the present invention, a terminal device enters a first coverage area associated with a first access point, establishes a first link with the first access point, and receives service description data from the first access point. From this service description data, the terminal device selects a first group key. This first link is then authenticated and a communications session is established with the first access point.

When the terminal device enters a second coverage area associated with a second access point, it establishes a second link with the second access point. Upon receiving service description data from the second access point, the terminal device selects a second group key based on this service description data. The terminal device then authenticates the second link using the second group key, and continues the communications session with the second access point.

### BRIEF DESCRIPTION OF THE DRAWINGS

In the drawings, like reference numbers generally indicate identical, functionally similar, and/or structurally similar elements. The drawing in which an element first appears is indicated by the leftmost digit(s) in the reference number.

The present invention will be described with reference to the accompanying drawings, wherein:

FIG. 1 is a block diagram of an exemplary operational environment embodying the present invention;

FIGS. 2A and 2B are block diagrams of an exemplary terminal device embodying the present invention;

FIG. 3 is a block diagram of an exemplary access point;

FIG. 4 is a diagram of an exemplary handover scenario;

FIG. 5 is a diagram of a signaling sequence in a handover process according to an embodiment of the present invention;

FIG. 6 is a flowchart of an exemplary authentication and pairing process;

FIG. 7 is a flowchart of an exemplary service discovery process;

FIG. 8 is a flowchart of a handover operation performed by an access point, according to an embodiment of the present invention;

FIG. 9 is a flowchart of a handover operation performed by a terminal device according to an embodiment of the present invention;

FIGS. 10 and 11 are diagrams of signaling sequences in handover processes that eliminate the need for full authentication and pairing, according to embodiments of the present invention;

FIG. 12 is a block diagram of an operational environment according to a further embodiment of the present invention;

FIGS. 13 and 14 are diagrams of signaling sequences in handover processes that eliminate the need for full authentication and pairing, according to further embodiments of the present invention; and

FIG. 15 is a block diagram of a computer system.

### DETAILED DESCRIPTION OF THE PREFERRED EMBODIMENTS

I. Exemplary Operational Environment

In the following description of the various embodiments, reference is made to the accompanying drawings which form a part hereof, and in which is shown by way of illustration, various embodiments in which the invention may be practiced. It is to be understood that other embodiments may be utilized and structural and functional modifications may be made without departing from the scope of the present invention.

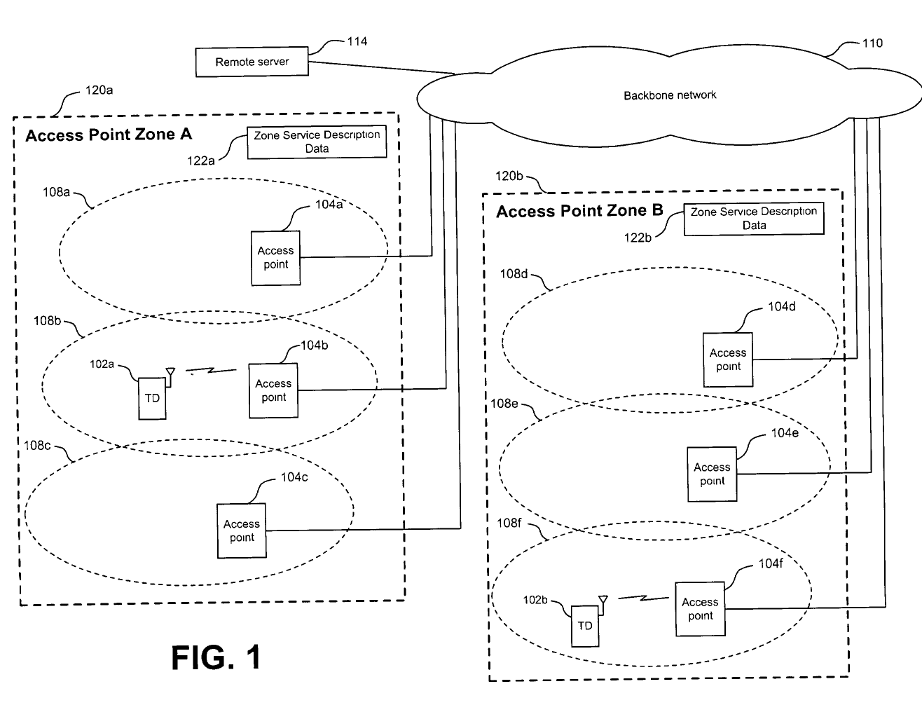

Before describing the invention in detail, it is helpful to describe an environment in which the invention may be used. Accordingly, FIG. 1 is a block diagram of an operational environment embodying the present invention where multiple terminal devices 102 communicate with access points 104 across various ad hoc networks. Communications between these terminals may be performed according to various personal area network (PAN) standards, such as the Bluetooth communications standard.

FIG. 1 shows that each access point 104 has a corresponding coverage area 108. Each of these coverage areas 108 identifies the locations where the corresponding access point 104 may engage in communications with terminal devices 102. An exemplary coverage area is between 10 and 15 meters in diameter. However, other coverage area sizes may be used. As shown in FIG. 1, coverage areas 108a-f correspond to access points 104a-f, respectively. These coverage areas may overlap. For example, coverage area 108a overlaps with coverage area 108b and coverage area 108b overlaps with coverage area 108c. FIG. 1 shows a terminal device 102a communicating with access point 104b, and a terminal device 102b communicating with access point 104f.

In many communications applications, terminal devices may be portable. Therefore, they may move through more than a single coverage area 108 during the course of a communications session. More particularly, the process of a communications session being transferred from a first access point to a second access point is referred to herein as a handover. The present invention provides mechanisms that allow handovers to occur without excessively interrupting ongoing communications sessions.

As described above, the present invention enables terminal devices to efficiently transition from a first access point to a second access point based on service description information that is transmitted by the second access point. To implement this feature, the present invention groups one or more access points into access point zones. In many scenarios, the service description information that is sent by the second access point includes the same information that was provided by the first access point. This is because each access point zone may have a single ID indicating itself. Thus, each of the access points in a particular access point zone will advertise the same access zone identifier. However, embodiments of the present invention may employ multiple IDs in a single access point zone. Such techniques involving multiple IDs are described in greater detail below.

FIG. 1 shows that access points 104a, 104b, and 104c are included in an access point zone 120a. Similarly, access points 104d, 104e, and 104f are included in an access point zone 120b. Although FIG. 1 shows access point zones 120 that each include three access points, access point zones may be employed having any number of access points.

Access point zones 120 may each correspond to certain geographical landmarks. For example, an access point zone 120 may physically cover an area such as a shopping center or a train station. Although some of these zones 120 may encompass a contiguous geographical region, other zones 120 may cover multiple isolated regions. Such isolated regions may correspond to, for example, traffic hot spots in a landmark such as a train station. Such configurations help control the distribution of traffic and processing loads among access points 104.

Zone service description data exists for each access point zone 120. For example, FIG. 1 shows service description data 122a that corresponds to zone 120a and service description data 122b that corresponds to zone 120b. Each access point 104 in a particular zone 120 advertises its corresponding zone service description data 122 when terminal devices 104 are seeking to establish communications with them. From this service description data, terminal devices 104 obtain information, such as link keys. This information enables such communications to be established. A network ID (also referred to herein as an access zone ID) is an example of such service description data. Access zone IDs are described in greater detail below.

Zone service description data 122 may be stored locally in each access point 104. Alternatively, zone service description data 122 may be stored remotely in a description data server (not shown). Access points 104 in a particular zone 120 may obtain this data from such a server across a network, or through wireless links, such as Bluetooth links. However, one or more access points 104 may include a description data server.

Each access point 104 is connected to a backbone network 110 (also referred to herein as access point network 110). Backbone network 110 may be implemented with various technologies. For instance, backbone network 110 may include an IP network, such as the Internet. Backbone network 110 may also include telephony networks. Backbone network 110 may also be implemented with wireless technologies, such as WLAN and even Bluetooth, wherein some or all of the access points have overlapping coverage areas to provide connectivity between access points 104 and other entities, such as remote server 114.

Backbone network 110 allows access points 104 to communicate with each other. Such communications may allow portable terminal devices in different coverage areas to communicate with each other. Backbone network 110 also enables terminal devices to engage in communications sessions with remote devices. For example, terminal devices may receive information, such as Internet content, from remote server 114. In addition, communications sessions may include other communications services, such as telephony. Such telephony may include connections between terminal devices 104, as well as connections with other devices (not shown). Backbone network 110 facilitates such connections.

II. Exemplary Terminal Device

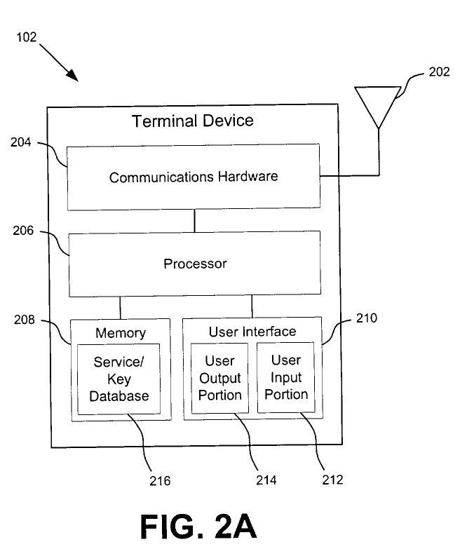

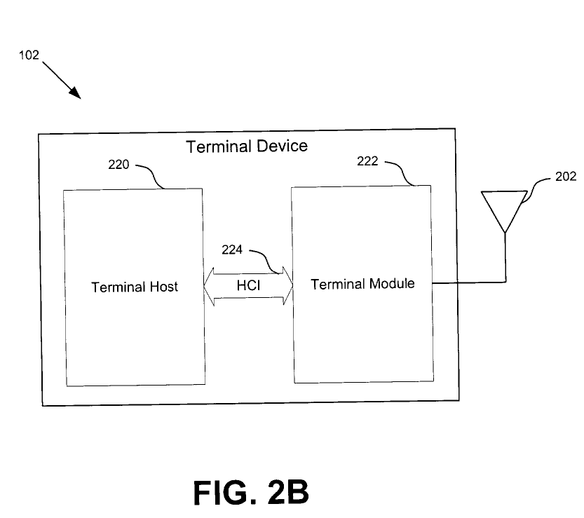

Since the present invention may be employed in environments involving wireless communications, a device capable of engaging in such communications is described. FIGS. 2A and 2B are block diagrams of an exemplary terminal device 102 implementation embodying the present invention. Terminal device 102 may be a wireless mobile phone, a wireless PDA, a pager, a two-way radio, a smartphone, a personal communicator, a laptop computer equipped with a Bluetooth (BT) module, or other wireless devices apparent to persons skilled in the relevant arts.

FIG. 2A shows that terminal device 102 includes several components. For instance, terminal device 102 includes a communications hardware portion 204 that is coupled to an antenna 202. Communications hardware portion 204 includes electronics, such as a transceiver and a diplexer. These electronics allow terminal device 102 to engage in bi-directional RF communications with network entities, such as base stations and Bluetooth access points.

A processor 206 is coupled to communications hardware portion 204. Processor 206 controls all of the functions of terminal device 102. Processor 206 may be implemented with one or more microprocessors that are each capable of executing software instructions stored in a memory 208.

A user interface 210 is coupled to processor 206. User interface 210 facilitates the exchange of information with a user. FIG. 2A shows that user interface 210 includes a user input portion 212 and a user output portion 214. User input portion 212 may include one or more devices that allow a user to input information. Examples of such devices include keypads, touch screens, and microphones. User output portion 214 allows a user to receive information from terminal device 102. Thus, user output portion 214 may include various devices, such as a display, and one or more audio speakers. Exemplary displays include liquid crystal displays (LCDs), and video displays.

Memory 208 stores information in the form of data and software components. These software components include instructions that can be executed by processor 206. Various types of software components may be stored in memory 208. For instance, memory 208 may store software components that control the operations of communications hardware portion 204, and software components that control the exchange of information through user interface 210. In addition, memory 208 stores software components that are associated with user applications that allow terminal device 102 to engage in communications sessions involving services, such as telephony and remote server access.

As shown in FIG. 2A, memory 208 includes a service/key database 216. Database 216 maintains correspondences between service description data and link keys. Accordingly, in the context of FIG. 1, when a particular access point 104 advertises service description data, a terminal device 102 that receives this data may access database 216 to determine an appropriate key to use in establishing communications with the advertising access point 104.

The above components may be coupled according to various techniques. One such technique involves coupling communications hardware 204, processor 206, memory 208, and user interface 210 through one or more bus interfaces. In addition, each of these components is coupled to a power source, such as a removable and rechargeable battery pack (not shown).

FIG. 2B is a block diagram illustrating how the components of FIG. 2A may be allocated between two segments: a terminal host 220, and a terminal module 222. Terminal host 220 is responsible for user applications and higher protocol layers, while terminal module 222 is responsible for lower layer protocols. For example, in Bluetooth implementations, terminal module 222 performs link management and link control functions, as well as the transmission and reception of RF signals.

Terminal host 220 and terminal module 222 communicate according to a host controller interface (HCI) 224. Bluetooth specifies formats for messages and/or packets that cross HCI 224. Examples of such standard messages include terminal module 222 requesting a link key from terminal host 220, and terminal host 220 providing a link key to the terminal module 222.

As described above, memory 208 stores software components that are associated with user applications. Exemplary user applications allow terminal device 102 to select and receive content items during a session with remote server 114. Since such user applications may involve the exchange of information with remote server 114, memory 208 stores software components that enable communications with remote server 114 according to protocols, such as the Wireless Application Protocol (WAP).

When engaging in WAP communications with remote server 114, terminal device 102 functions as a WAP client. To provide this functionality, terminal host 220 includes WAP client software, such as WAP Client Version 2.0. WAP Client Version 2.0 is a commercially available software product provided by Nokia Corporation of Finland. WAP Client Version 2.0 contains components, such as a Wireless Markup Language (WML) Browser, a WMLScript engine, a Push Subsystem, and a Wireless Protocol Stack.

Application software components stored in memory 208 of terminal device 102 interact with the WAP client software to implement a variety of communications applications. Examples of such communications applications include the reception of Internet-based content, such as headline news, exchange rates, sports results, stock quotes, weather forecasts, multilingual phrase dictionaries, personal online calendars, and online travel and banking services.

WAP-enabled terminal device 102 may access small files called decks which are each composed of smaller pages called cards. Cards are small enough to fit into a small display area that is referred to herein as a microbrowser. The small size of the microbrowser and the small file sizes are suitable for accommodating low memory devices and low-bandwidth communications constraints imposed by the wireless portions of communications networks.

Cards are written in the Wireless Markup Language (WML), which is specifically devised for small screens and one-hand navigation without a keyboard. WML is scaleable so that it is compatible with a wide range of displays that covers two-line text displays, as well as large LCD screens found on devices, such as smart phones, PDAs, and personal communicators.

WML cards may include programs written in WMLScript, which is similar to JavaScript. However, through the elimination of several unnecessary functions found in these other scripting languages, WMLScript makes minimal demands on memory 208 and processor 206.

III. Exemplary Access Point

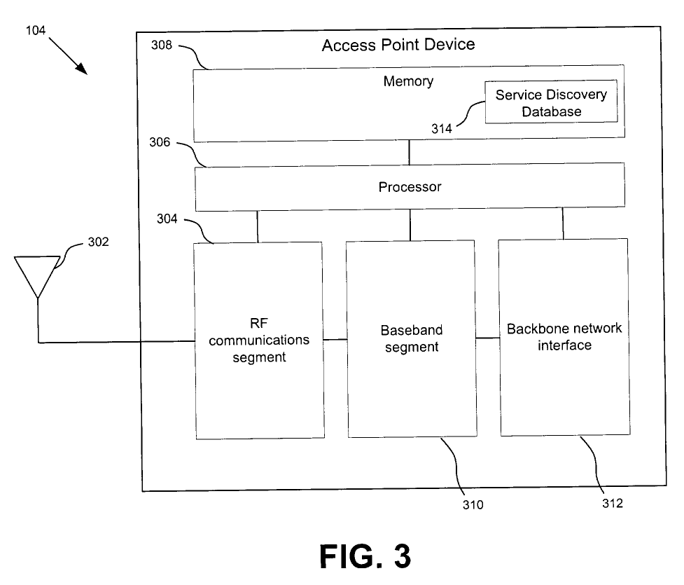

FIG. 3 is a block diagram of an implementation of an exemplary access point device 104 embodying the present invention. FIG. 3 shows that this implementation includes several components. For instance, access point device 104 includes a radio frequency (RF) communications portion 304 that is coupled to an antenna 302. RF communications portion 304 includes electronics, such as a transceiver and a diplexer. These electronics allow access point 104 to engage in bi-directional RF communications with terminal devices 102. In addition, these electronics allow access point to communicate with other access points within its coverage area.

A baseband segment 310 is coupled to RF communications portion 304. Baseband segment 310 performs connection processing functions, such as link establishment and termination, as well as security functions, such as authentication, pairing, and encryption. A backbone network interface 312 is coupled to baseband segment 310. Backbone network interface 312 handles communications with other devices across backbone network 110.

A processor 306 is coupled to RF communications portion 304, baseband segment 310, and backbone network interface 312. Processor 306 controls all of the functions of the access point device. Processor 306 may be implemented with one or more microprocessors that are each capable of executing software instructions stored in a memory 308.

Memory 308 stores information in the form of data and software components. These software components include instructions that can be executed by processor 306 to control the operation of the access point device components shown in FIG. 3. FIG. 3 shows that memory 308 also includes a service discovery database 314. This database contains service discovery information that is transmitted to terminal devices so that they may efficiently transition between access points according to the techniques described herein.

Service discovery database 314 includes a set of records describing all the services that the access point device 104 can offer to a terminal device 102. These service records may be arranged in a variety of ways.

For instance, in Bluetooth implementations, these records in service discovery database 314 may be arranged according to SDP. That is, each SDP service record includes a collection of service attributes containing various information. For example, attributes may describe the protocol stack layers that are needed to interact with the service, as well as descriptive information about the service that is in a format readable by a terminal device's user.

The components shown in FIG. 3 may be coupled according to various techniques. One such technique involves coupling RF communications segment 304, processor 306, and memory 308 through one or more bus interfaces.

IV. Exemplary Handover Scenario

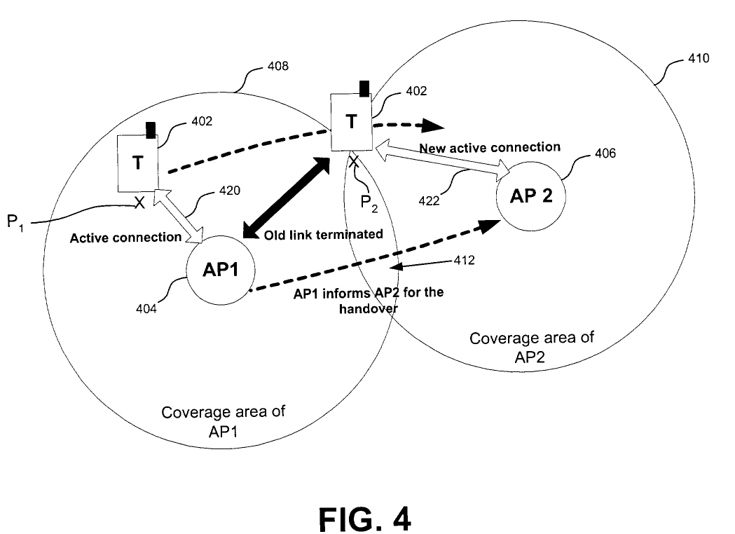

FIG. 4 is a diagram of an exemplary handover scenario. This scenario involves a first access point 404 and a second access point 406. Each of these access points has a limited coverage area. For instance, access point 404 has a coverage area 408, while access point 406 has a coverage area 410. These coverage areas overlap at a handover region 412.

In this scenario, a terminal device 402 moves from a position P₁ to a position P₂. As shown in FIG. 4, position P₁ is within coverage area 408, while position P₂ is within handover region 412 (i.e., P₂ is within both coverage areas 408 and 410).

While at position P₁, terminal device 402 has a short range wireless communications connection or link 420 with access point 404. During this connection, terminal device 402 is involved in a communications session with one or more other devices. Link 420 continues until terminal device 402 reaches position P₂. At this point, connection 420 is terminated, and a new short range wireless connection or link 422 is established and authenticated between terminal device 402 and access point 406. Through link 422, terminal device 402 maintains the communications session previously carried over link 420. For example, this communications session may involve the reception of content (such as multimedia) from remote server 114.

The scenario of FIG. 4 illustrates a second connection being established in a handover region that includes two overlapping coverage areas. However, in other scenarios, second connection 422 may be established after terminal 402 has completely left a first coverage area, and entered a second coverage area.

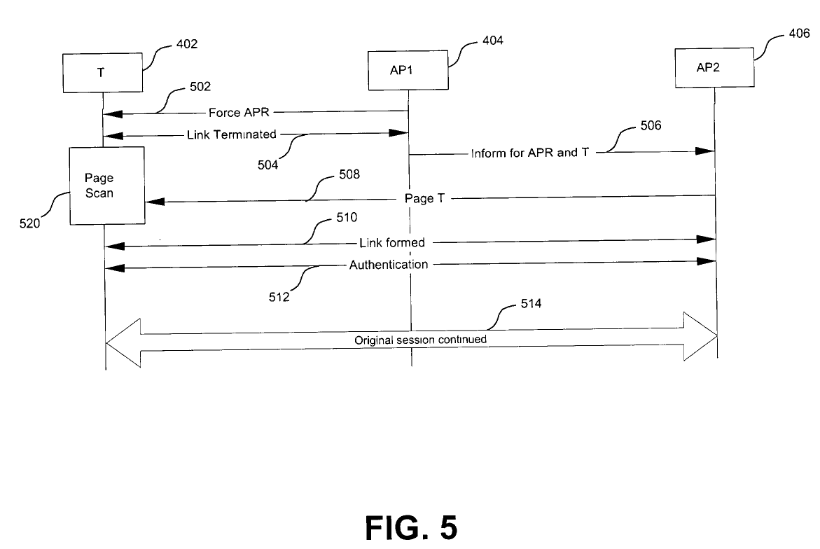

Handovers may be either access point initiated or terminal initiated. FIG. 5 is a diagram of a signaling sequence in an access point initiated handover process according to an embodiment of the present invention. More particularly, FIG. 5 illustrates a series of steps that shows how terminal device 402 interacts with access points 404 and 406 during an access point initiated handover. Although this signaling sequence is described with reference to the elements of FIG. 4, this illustrated process may be applied to other scenarios and topologies.

First, in a step 502, access point 404 “forces” an access point roaming (APR) handover when terminal device 402 is at point P₂. This step comprises access point 404 transmitting a message to terminal device 402 that its link will be terminated. Although FIG. 5 shows access point 404 forcing an APR handover, terminal 402 may initiate the handover. In this case, step 502 comprises terminal 402 sending a message or query to access point 404 for access point roaming.

Next, in a step 504, the link between terminal device 402 and first access point 404 is terminated. Following this termination, terminal device 402 enters a page scan state 520. While in this state, terminal device 402 waits to receive a message containing information based on its address.

In a step 506, access point 404 notifies access point 406 of the pending handover. This step includes providing access point 406 with the address of terminal device 402. Next, in a step 508, access point 406 pages terminal device 402. In the context of Bluetooth, paging is a process that establishes a connection between two devices. With reference to FIG. 4, this process involves the exchange of information between access point 406 and terminal device 402.

More particularly, during this paging process, access point 406 enters a paging mode and transmits one or more paging packets. These paging packets each include an identification number based on the address of terminal device 402. Meanwhile, terminal device 402 (which is in page scan mode) responds to the paging packets by transmitting a packet that includes its address.

Access point 406 receives this packet from terminal device 402. In response, access point 406 transmits a frequency hop synchronization (FHS) packet. The FHS packet is used to pass information that allows terminal device 402 to synchronize with the frequency hopping sequence of access point 406. Upon receipt of this FHS packet, terminal device 402 transmits a further packet to confirm receipt of the FHS packet. Both terminal device 402 and access point 406 enter into the connection state at this point. When in this state, access point 406 operates as a master device and terminal device 402 operates as a slave device.

Upon completion of this paging process, a step 510 is performed. In step 510, a link is formed between terminal device 402 and second access point 406. In particular, terminal device 402 synchronizes its clock to the clock of access point 406. Thus, terminal device 402 employs the timing and frequency hopping sequence of access point 406. Additionally, access point 406 transmits a packet to verify that a link has been set up. Terminal device 402 confirms this link by sending a packet to access point 406.

In a step 512, terminal device 402 and the access point 406 conduct authentication and pairing processes. Next, in a step 514, terminal device 402 continues its communications session.

As set forth above, security features are desired for various types of communications services. Features, such as encryption, require both devices to share an encryption key. Authentication is a security procedure where two devices exchange information to verify that they both have the same encryption key.

If this authentication reveals that the two devices do not share an encryption key, then a process, referred to as pairing is performed. Pairing is a procedure that establishes a link key for use between two devices. As stated above, valuable processing capacity and network bandwidth are consumed when both authentication and pairing processes need to be performed. In addition, valuable time will also be lost when both authentication and pairing processes need to be performed. Adverse consequences may result from this loss of time. For instance, terminal 402 may move out the coverage area of access point 406.

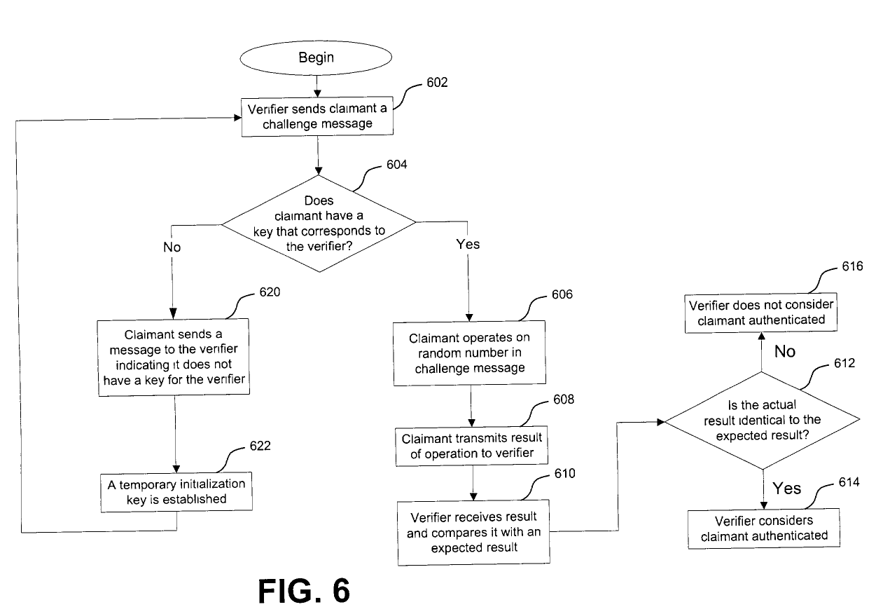

Details of Bluetooth authentication and pairing processes are now described with reference to the flowchart of FIG. 6. This flowchart illustrates that these processes are based on a challenge-response protocol that occurs between a verifier device (such as access point 406) and a claimant device (such as terminal device 402).

The process illustrated in FIG. 6 begins with a step 602, where a verifier challenges a claimant by sending the claimant a challenge message. This challenge message includes a random number. In the context of Bluetooth, this challenge message is in the format of an LMP_au_rand packet and contains a 16-byte random number.

In a step 604, the claimant receives the challenge message and determines whether it has a key that corresponds to the verifier. If so, the authentication process continues and a step 606 is performed. Otherwise, operation proceeds to a step 620, where the pairing process commences.

In step 606, the claimant operates on the random number in the challenge message. Next, in a step 608, the claimant transmits the result of this operation to the verifier. In the context of Bluetooth, this transmission is in the format of an LMP_sres packet.

In a step 610, the verifier receives the result from the claimant and compares it to an expected result. As shown by step 612, if the result is the same as the expected result, operation proceeds to a step 614 where the verifier considers the claimant an authenticated device. Otherwise, operation proceeds to a step 616, where the verifier does not consider the claimant an authenticated device.

As described above, the pairing process commences when the verifier and claimant devices do not have a common link key. Accordingly, if a link key does not exist for a device when a challenge message is received, a pairing process is performed so that a link key may be established between the two devices. Accordingly, step 620 follows step 604 when the claimant determines that it does not have a key that corresponds to the verifier. In step 620, the claimant will respond with a message indicating that it does not have a key for the verifier device. In the context of Bluetooth, this message is an LMP_not_accepted packet.

In a step 622, a temporary initialization key is generated. The initialization key may be generated according to various techniques. For example, this key may be based on a personal identification number (PIN) that is common to both of the pairing devices (i.e., both the verifier and the claimant). Performance of step 622 may be performed without transmitting the PIN and the temporary key between the verifier and the claimant.

Since the verifier and the claimant have established a common key between them, the authentication process may continue. Accordingly, operation returns from step 622 to step 602. However, in the context of Bluetooth, when step 602 is performed after step 622, the verifier transmits the LMP_in_rand packet instead of the LMP_au_rand packet.

Upon completion of the authentication process described with reference to FIG. 6, the two devices may optionally exchange their roles as verifier and claimant and perform authentication in the opposite direction.

As illustrated in FIG. 6, performance of both authentication and pairing is an involved process. The present invention streamlines access point roaming by eliminating the need to perform both authentication and pairing at each handover. Thus, the present invention advantageously reduces the time required to perform handovers. In addition, the present invention advantageously reduces the processing resources required to perform handovers by using keys corresponding to access zone IDs that are accessed from a database. Moreover, the present invention advantageously reduces the communications bandwidth required to perform handovers by eliminating excessive pairing communications that occur between terminal devices and access points.

As described above, the present invention enables terminal devices to efficiently transition communications from a first access point to a second access point based on service description information that is transmitted by the second access point. To implement this feature, the present invention provides a correspondence between link keys and the service description data that access point(s) in an access point zone advertise.

V. Service Discovery

Terminal devices obtain such service description information through the exchange of messages. In Bluetooth implementations, this exchange of messages is performed according to the Service Discovery Protocol (SDP). As described above, access points, such as the access point shown in FIG. 3, each include a service discovery database. This database includes a set of records that, according to SDP, may each include a collection of service attributes. These service attributes each have an attribute identifier and an attribute value. One of these service attributes is known as a service record handle. The service record handle operates as a pointer to the service record. The client uses the service record handle to access the service record at the server.

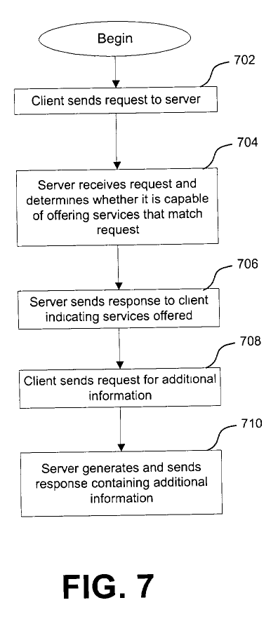

FIG. 7 is a flowchart of an exemplary service discovery process embodying the present invention. This process involves the exchange of messages between a client (such as terminal device 402) and a server (such as access point 406).

The process of FIG. 7 begins with a step 702, where the client sends a request to the server. This request indicates one or more services that the client is interested in. In the context of Bluetooth, this step comprises sending a ServiceSearchRequest protocol data unit (PDU).

Next, in a step 704, the server receives this request and determines whether it is capable of offering services that match this request. If so, then a step 706 is performed. In this step, the server sends a response to the client that indicates the services that match the request. In the context of Bluetooth, this step comprises the server sending a ServiceSearchResponse PDU. The ServiceSearchResponse PDU includes handles to one or more services that match the request sent in step 702. These handles indicate service(s) the server is capable of providing.

In a step 708, the client may send the server a request for additional information regarding these services that the client is interested in. In the context of Bluetooth, this step comprises the client sending a ServiceAttributeRequest PDU. A step 710 follows step 708. In this step, the server receives this request for additional information. In response, the server generates a response containing this additional information. In the context of Bluetooth, this step comprises sending the client a ServiceAttributeResponse PDU. The PDU includes attribute values associated with the attributes indicated by the client in step 708.

As an alternative to the steps shown in FIG. 7, a more efficient service discovery transaction may be performed. In Bluetooth/SDP implementations, such a simpler transaction is called a ServiceSearchAttribute transaction. In this transaction, a client sends a ServiceSearchAttributeRequest PDU to a server. This request specifies particular services as well as particular attributes associated with these services. In response, the server sends a ServiceSearchAttributeResponse PDU to the client. If the server provides these services, the response includes the values of the attributes specified in the request.

Following such exchanges of information, the client is now able to utilize the information received from the server to establish a connection with a selected service. Moreover, according to the present invention, the client (i.e., the terminal device) is also able to utilize certain service discovery information received from the server (i.e., the access point) to establish communications during transitions between access points. In embodiments, this service discovery information is a network ID provided by the access point, for example, as an attribute value in a Bluetooth SDP record.

This network ID is, for example, an IEEE-assigned MAC (medium access control) address. A MAC address uniquely identifies a particular node in an IEEE 802 network, such as an Ethernet. In the context of Bluetooth, a BD_ADDR, which uniquely identifies a Bluetooth device, is an IEEE MAC address.

In embodiments, the network ID is advertised in a SDP record as a provider ID. In access point zones having a plurality of access points, this provider ID may be the address (e.g., the BD_ADDR) of one of the access points in the access point zone. Alternatively, this provider ID may be another IEEE MAC address that corresponds to an entity responsible for administrating the access point zone. Such a provider ID is also referred to herein as an access zone ID.

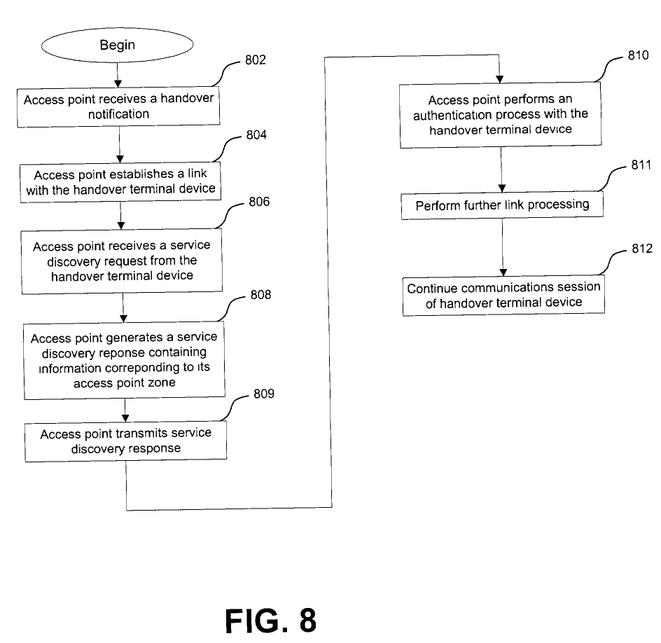

As described in greater detail below, an access point advertises discovery information, such as a network ID or a provider ID, to enable user terminals to select an appropriate group key. For example, the terminal device implementation of FIG. 2A may access its service/key database 216 according to a network ID or a provider ID received as part of a SDP transaction. Further details regarding this feature are provided below with reference to FIGS. 8-11.

VI. Service Description Based Handovers

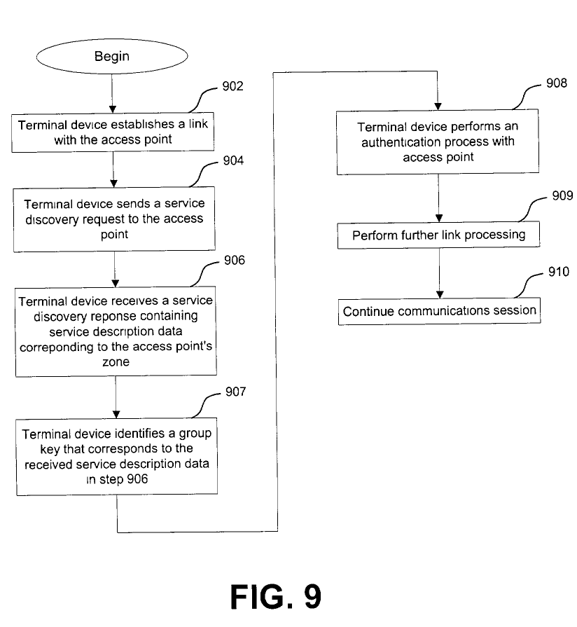

FIGS. 8 and 9 are flowcharts that illustrate streamlined handovers from different perspectives. In particular, FIG. 8 illustrates the perspective of a current access point acquiring a terminal device connection from a previous access point. FIG. 9 illustrates the perspective of a terminal device that is engaged in a handover from a first access point to a second access point. It is important to note that the steps of FIGS. 8 and 9 may be performed in sequences other than the ones shown.

FIG. 8 is a flowchart of a handover operation performed by an access point according to an embodiment of the present invention, such as access point 406, into which a terminal device, such as terminal device 402, is roaming. This operation is described with reference to the operational scenario of FIG. 4. The process shown in FIG. 8 begins with a step 802. In this step, access point 406 receives a handover notification from access point 404.

This handover notification may include various types of information. For example, it may include the address of terminal device 402. The handover notification may also include an access point address, such as the address of access point 404. The transmission of such access point addresses enables access point 406 to page terminal 402.

Access point 404 may transmit this handover notification to access points in addition to access point 406. For example, access point 404 may transmit this handover notification to all access points (including access point 406) within a predetermined range.

A step 804 follows step 802. In this step, access point 406 establishes a link with terminal device 402. This step may comprise performing a paging process, such as the Bluetooth paging process described above with reference to FIG. 5.

Step 804 may further comprise establishing various protocol connections or sessions between access point 406 and terminal device 402. For example, step 804 may comprise, in Bluetooth implementations, establishing link management protocol (LMP) and/or logical link control and adaptation protocol (L2CAP) connections. LMP is a protocol that establishes the properties of a wireless interface between two devices. In addition, LMP is responsible for performing operations, such as authentication and pairing. L2CAP is a higher layer protocol than LMP. L2CAP provides an interface between the link management protocol and higher protocol layers and applications. In particular, L2CAP provides functionality, such as protocol multiplexing as well as the segmentation and reassembly of large packets employed by applications and higher layer protocols.

A step 806 follows step 804. In this step, access point 406 receives a service discovery request from terminal device 402. Next, in a step 808, access point 406 generates a service discovery response from the received request. This response includes service description data (also referred to herein as service discovery information) that corresponds to the access point zone of access point 406. In a step 809, access point 406 transmits this service description data to terminal device 402.

Next, in step 810, access point 406 performs an authentication process with terminal device 402. During this step, access point 406 operates as the verifier and terminal device 402 operates as the claimant. This authentication process uses a group key that corresponds to the service description data that was transmitted to terminal device 402 in step 809.

With reference to the authentication process of FIG. 6, step 810 comprises access point 406 transmitting a challenge message to terminal device 402. Terminal device 402 receives and processes this message with the group key corresponding to the previously transmitted service description data. This processing yields a result that is transmitted to access point 406.

Step 810 further comprises access point 406 receiving this result and comparing it to an expected result that is based on the group key corresponding to the service description data transmitted in step 809. The received and expected results match. Accordingly, terminal device 402 and access point 406 do not have to perform a pairing process.

Alternatively, step 810 may comprise access point 406 acting as a claimant, and terminal device 402 acting as a verifier. This authentication is also based on the group key that terminal device 402 determines from the service description data transmitted in step 809. After access point 406 is authenticated by terminal device 402, access point 406 then authenticates terminal device 402. By following this alternative two-step procedure, terminal device 402 can prevent a fake network or access point from obtaining authentication messages (such as Bluetooth rand_sres messages) to determine a group key.

In a step 811, access point 406 may perform further link processing with terminal device 402. For example, an encryption key for secure communications may be established between access point 406 and terminal device 402. Such an encryption key may be based on the link key used during the aforementioned authentication process.

In addition, step 811 may comprise access point 406 interacting with terminal device 402 to establish further protocol connections. For example, a connection according to the Bluetooth network encapsulation protocol (BNEP) may be established. BNEP is a protocol that allows Ethernet frames with Internet Protocol (IP) traffic to be carried across Bluetooth connections. BNEP operates directly above L2CAP and allows the multiplexing of several higher layer protocols, including IP.

A step 812 follows step 811. In step 812, the communication session of terminal device 402 is continued. As described above, this communications session may involve the ongoing exchange of information with other devices, such as remote server 114.

FIG. 9 is a flowchart of a handover operation performed by a roaming terminal device, such as terminal device 402, according to an embodiment of the present invention. Like FIG. 8, this operation is described with reference to the operational scenario of FIG. 4. The process shown in FIG. 9 begins with a step 902.

In step 902, terminal device 402 establishes a link with access point 406. This step may comprise engaging in a paging process, such as the Bluetooth paging process described above with reference to FIG. 5. Step 902 may further comprise establishing various protocol connections or sessions between access point 406 and terminal device 402. For example, step 902 may comprise, in Bluetooth implementations, establishing link management protocol (LMP) and/or logical link control and adaptation protocol (L2CAP) connections.

Next, in a step 904, terminal device 402 sends a service discovery request to access point 406. In a step 906, terminal device 402 receives a service discovery response from access point 406. This response includes service description data (also referred to herein as service discovery information) that corresponds to the access point zone of access point 406.

Next, in a step 907, terminal device 402 identifies a group key that corresponds to the service description data received in step 906. With reference to the terminal device implementation shown in FIG. 2A, this step comprises processor 206 accessing the group key from service/key database 216.

In a step 908, terminal device 402 and access point 406 perform an authentication process. With reference to the authentication process of FIG. 6, step 908 comprises terminal device 402 receiving a challenge message from access point 406. Terminal device 402 processes this message with the group key corresponding to the previously transmitted service description data. This processing yields a result that terminal device 402 transmits to access point 406. This result, when received by access point 406, matches an expected result. Therefore, according to the present invention, terminal device 402 and access point 406 do not have to perform a pairing process.

Alternatively, step 908 may comprise terminal device 402 acting as a verifier to authenticate access point 406, which acts as a claimant. This authentication is also based on the group key that terminal device 402 identified in step 907. After terminal device 402 authenticates access point 406, it is authenticated by access point 406. By following this alternative two-step procedure, terminal device 402 can prevent a fake network or access point from obtaining authentication messages (such as Bluetooth RAND_SRES messages) to determine a group key.

In a step 909, terminal device 402 may perform further link processing with access point 406. For example, an encryption key for secure communications may be established between terminal device 402 and access point 406. Such an encryption key may be based on the link key used during the aforementioned authentication process. In addition, step 909 may comprise terminal device 402 interacting with access point 406 to establish further protocol connections, such as a BNEP connection.

A step 910 follows step 909. In this step, the communication session of terminal device 402 is continued. As described above, this communications session may involve the ongoing exchange of information with other devices, such as remote server 114.

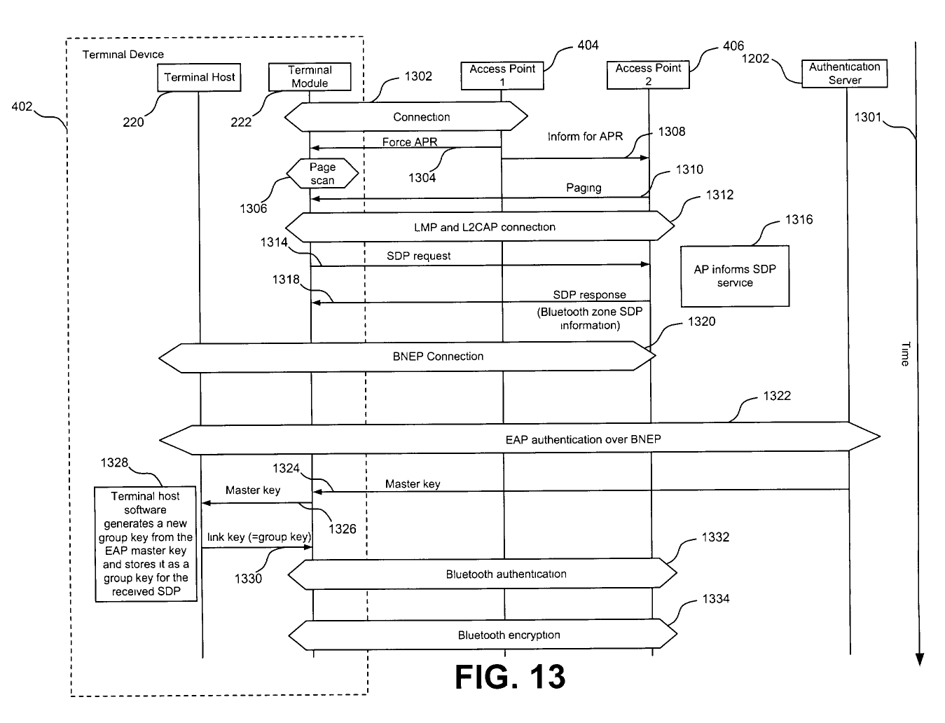

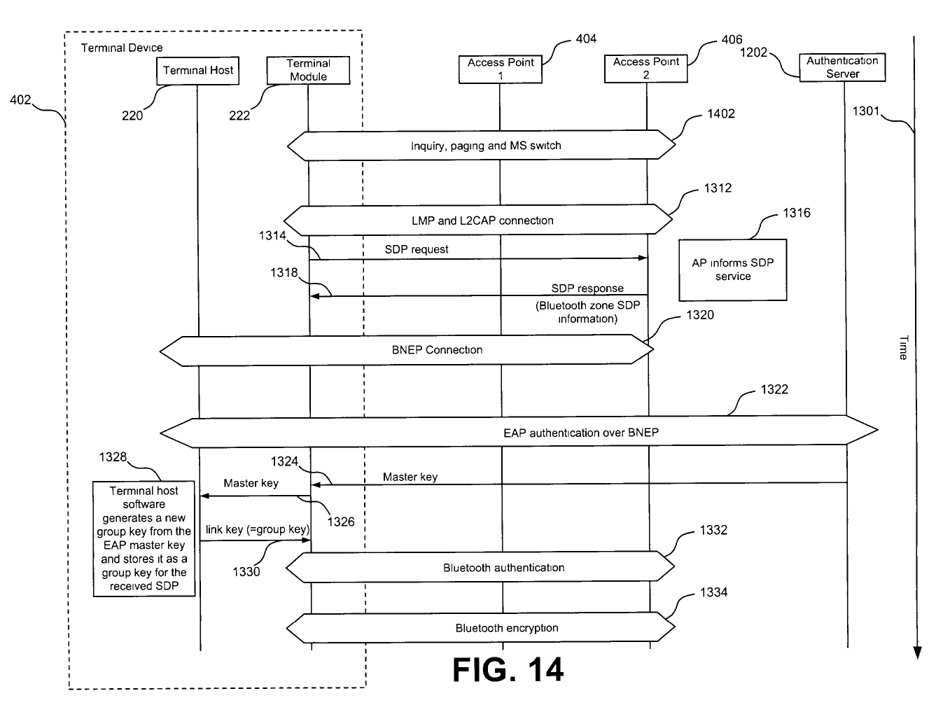

The flowcharts in FIGS. 8 and 9 show steps where further link processing, such as the establishment of BNEP connections occur after link authentication is performed. For instance, FIG. 8 shows further link processing being performed in step 811. This step follows authentication step 810. Also, FIG. 9 shows further link processing being performed in step 909. This step follows authentication step 908. However, in embodiments of the present invention, link processing, such as the establishment of BNEP connections may be performed before link authentication. Examples of such embodiments are described below with reference to FIGS. 13 and 14.

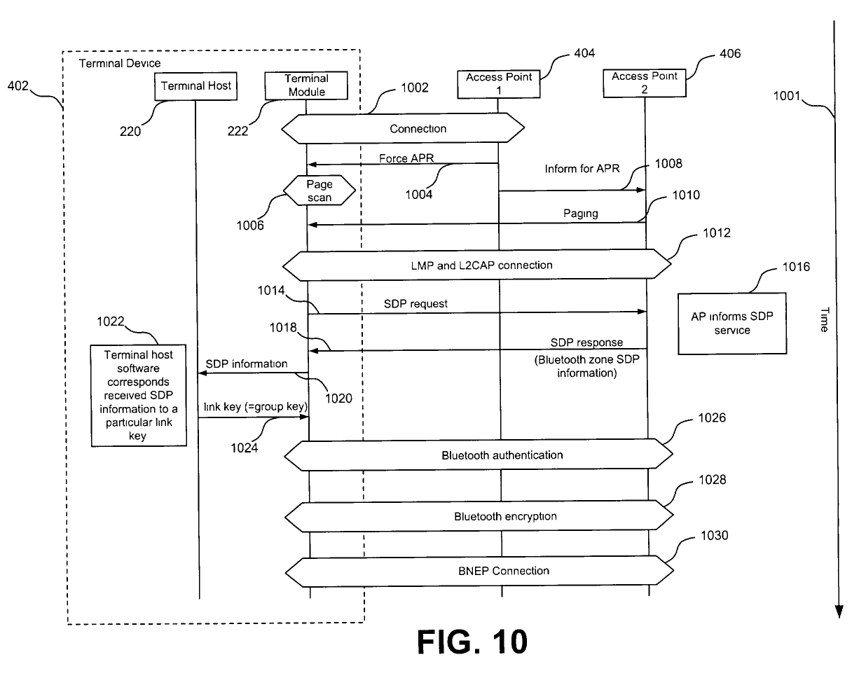

FIG. 10 is a diagram of a signaling sequence in accordance with the operations described above with reference to FIGS. 8 and 9. This signaling sequence eliminates the need for full authentication and pairing. In addition, for Bluetooth communications, this sequence involves the use of standard HCI commands. Therefore, the present invention advantageously does not require modifications to the Bluetooth terminal module.

FIG. 10 illustrates a series of steps that shows how terminal device 402 interacts with access points 404 and 406 during an access point initiated handover according to an embodiment of the present invention. These steps are shown to occur in a chronological sequence according to a time axis 1001. In addition, with reference to the terminal device implementation shown in FIG. 2B, FIG. 10 shows an interaction between terminal host 220 and terminal module 222.

This signaling sequence begins with a step 1002, where terminal device 402 is communicating across a connection with access point 404. Next, in a step 1004, access point 404 “forces” an APR handover when terminal device 402 is at point P₂. As described above with reference to FIG. 5, this step comprises access point 404 transmitting a message to terminal device 402 that its link will be terminated. Alternatively, the handover may be initiated by terminal device 402. As described above with reference to FIG. 5, such embodiments involve terminal 402 sending access point 404 a message or query to initiate a handover.

Steps 1006 and 1008 follow step 1004. In step 1006, terminal device 402 enters a page scan state, where it awaits one or more paging messages. In step 1008, access point 404 notifies access point 406 of the pending handover. This step includes providing access point 406 with the address of terminal device 402.

In a step 1010, access point 406 enters a paging mode and transmits one or more paging packets. These paging packets each include an identification number based on the address of terminal device 402. Meanwhile, during this step, terminal device 402 (which is in page scan mode) responds to the paging packets by transmitting a packet that includes its address.

Access point 406 receives this packet from terminal device 402. In response, access point 406 transmits a frequency hop synchronization (FHS) packet. The FHS packet is used to pass information that allows terminal device 402 to synchronize with the frequency hopping sequence of access point 406. Upon receipt of this FHS packet, terminal device 402 transmits a further packet to confirm receipt of the FHS packet. Both terminal device 402 and access point 406 enter into the connection state at this point. When in this state, access point 406 operates as a master device and terminal device 402 operates as a slave device.

A step 1012 follows the completion of this paging process. In this step, LMP and L2CAP connections are established between terminal device 402 and access point 406. As described above, LMP establishes the properties of a wireless interface between two devices. L2CAP provides functionality, such as protocol multiplexing and packet segmentation/reassembly.

Next, in a step 1014, terminal device 402 sends an SDP request to access point 406. FIG. 10 shows that terminal module 222 initiates this step. In a step 1016, access point 406 receives this request and generates an SDP response. This response is sent to terminal device 402 in a step 1018. Upon receipt of this response, terminal module 222 passes this response to terminal host 220 in a step 1020.

In a step 1022, terminal host 220 accesses a group key that corresponds to the SDP information received from access point 406. With reference to the terminal device implementation of FIG. 2A, this step comprises accessing service/key database 216. Terminal host 220 passes this corresponding link key to terminal module 222 in a step 1024.

A step 1026 follows step 1024. In this step, the link between access point 406 and terminal device 402 is authenticated based on the link key accessed in step 1022. Therefore, this authentication does not require pairing to be performed. After authentication, steps 1028, and 1030 are performed. In step 1028, an encryption key for secure communications is established between terminal device 402 and access point 406. Next, in step 1030, a BNEP connection is established between these devices.

It is possible that, when terminal device 402 accesses a group key in step 1022, it determines that the key has expired or that the key is currently invalid for the access zone ID. When this occurs, a BNEP connection may be established and the Extensible Authentication Protocol (EAP) may be performed to establish a new group key for terminal device 402 and access point 406. An exemplary EAP process is described below with reference to FIG. 13.

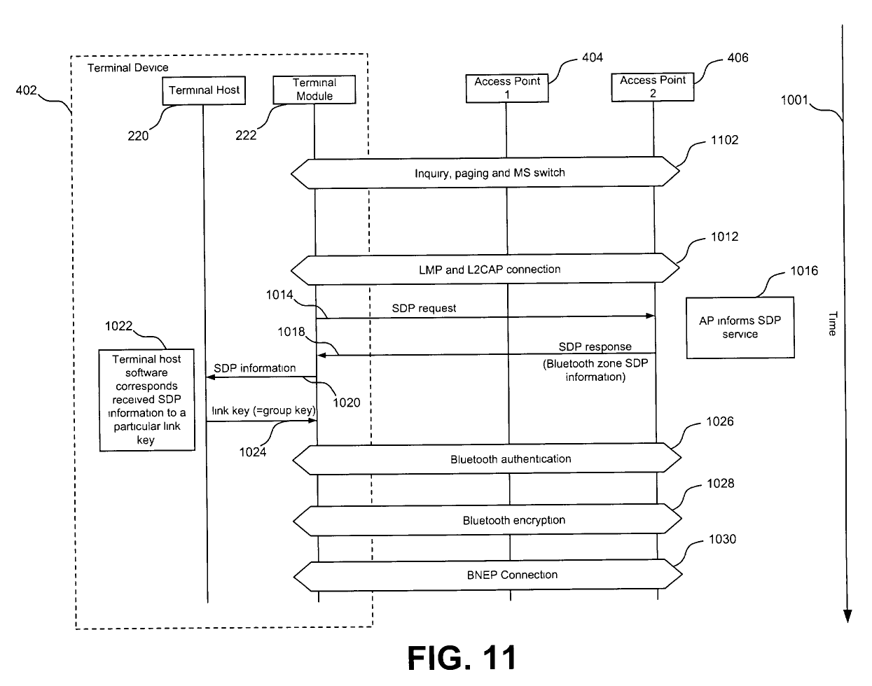

The handover scenario of FIG. 4 involves a notification sent from access point 404 to access point 406. This notification is further described in steps 802 and 1008 of FIGS. 8 and 10, respectively. However, embodiments of the present invention do not require such a handover notification to be sent between access points. FIG. 11 illustrates such an embodiment.

FIG. 11 shows a sequence of steps involving techniques of the present invention where terminal device 402 establishes a link with access point 406 in a manner that is different from FIG. 10. In particular, FIG. 11 replaces steps 1006, 1008, and 1010 with a step 1102.

In step 1102, terminal device 402 establishes a link with access point 406. However, in contrast to FIG. 10, this link is initiated by terminal device 402. In particular, step 1102 comprises terminal device 402 sending inquiry messages that result in its identification of access point 406. Next, terminal device 402 enters a page state and access point 406 enters a page scan state.

Once this occurs, terminal device 402 pages access point 406. this paging establishes a link between these devices, where terminal device 402 is the master and access point 406 is the slave. Next, a master/slave role switch (MS switch) occurs between these devices so that terminal device 402 is the slave and access point 406 is the master. This role switch may be initiated by either access device 406 or terminal device 402.

After step 1102, steps 1012 through 1030 are performed, as described above with reference to FIG. 10.

FIGS. 10 and 11 illustrate embodiments where, in the context of Bluetooth, a BNEP connection is established after Bluetooth authentication and Bluetooth encryption are performed. However, the present invention also includes embodiments where the BNEP connections may be established before Bluetooth authentication and encryption occurs. Moreover, such embodiments may include a further authentication step according to various protocols, such as the extensible authentication protocol (EAP).

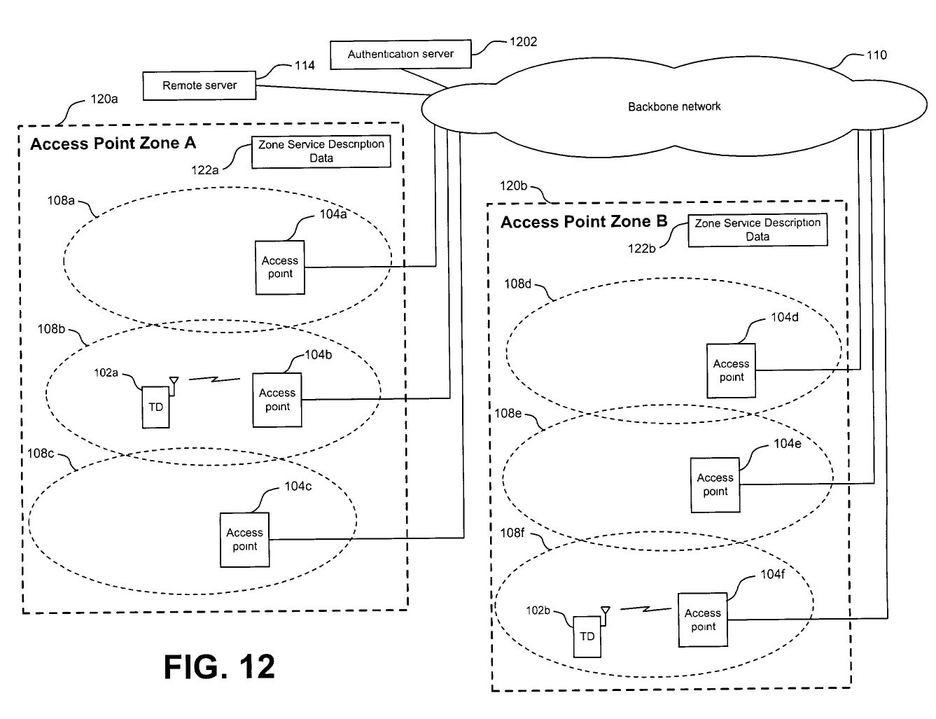

FIG. 12 is a block diagram of an operational environment according to such embodiments. This operational environment is similar to the environment shown in FIG. 1. However, the environment of FIG. 12 includes an authentication server 1202 coupled to backbone network 110. Authentication server 1202 provides authentication services according to a protocol, such as the Extensible Authentication Protocol (EAP). EAP is a protocol that is based on concepts provided in RFC 2284, published by Internet Engineering Task Force (IETF) in 1998. This document is incorporated herein by reference in its entirety.

FIG. 13 illustrates a sequence of steps that show how terminal device 402 interacts with access points 404 and 406, as well as an authentication server (such as authentication server 1202), during an access point initiated handover according to an embodiment of the present invention. These steps are shown to occur in a chronological sequence according to a time axis 1301. In addition, with reference to the terminal device implementation shown in FIG. 2B, FIG. 13 shows an interaction between terminal host 220 and terminal module 222.

This sequence begins with a step 1302, where terminal device 402 is communicating across a connection with access point 404. Next, in a step 1304, access point 404 “forces” an APR handover when terminal device 402 is at point P₂. As described above with reference to FIG. 5, this step comprises access point 404 transmitting a message to terminal device 402 that its link will be terminated. Alternatively, the handover may be initiated by terminal device 402. As described above with reference to FIG. 5, such embodiments involve terminal 402 sending access point 404 a message or query to initiate a handover.

Steps 1306 and 1308 follow step 1304. In step 1306, terminal device 402 enters a page scan state, where it awaits one or more paging messages. In step 1308, access point 404 notifies access point 406 of the pending handover. This step includes providing access point 406 with the address of terminal device 402.

In a step 1310, access point 406 enters a paging mode and transmits one or more paging packets. These paging packets each include an identification number based on the address of terminal device 402. Meanwhile, during this step, terminal device 402 (which is in page scan mode) responds to the paging packets by transmitting a packet that includes its address.

Access point 406 receives this packet from terminal device 402. In response, access point 406 transmits a frequency hop synchronization (FHS) packet. The FHS packet is used to pass information that allows terminal device 402 to synchronize with the frequency hopping sequence of access point 406. Upon receipt of this FHS packet, terminal device 402 transmits a further packet to confirm receipt of the FHS packet. Both terminal device 402 and access point 406 enter into the connection state at this point. When in this state, access point 406 operates as a master device and terminal device 402 operates as a slave device.

A step 1312 follows the completion of this paging process. In this step, LMP and L2CAP connections are established between terminal device 402 and access point 406. As described above, LMP establishes the properties of a wireless interface between two devices. L2CAP provides functionality, such as protocol multiplexing and packet segmentation/reassembly.

Next, in a step 1314, terminal device 402 sends an SDP request to access point 406. FIG. 13 shows that terminal module 222 initiates this step. In a step 1316, access point 406 receives this request and generates an SDP response. This response is sent to terminal device 402 in a step 1318. This response may include a network ID, such as a provider ID, that is an attribute in an SDP record.

In a step 1320, terminal device 402 establishes a personal area network (PAN) BNEP connection. Next, in a step 1322, the BNEP connection is authenticated. This authentication may be performed according to EAP. An exemplary EAP authentication process includes the following steps. First, an authentication server 1202 sends terminal device 402 an identity request. Terminal device 402 responds with an identifier that identifies itself to authentication server 1202. Next, authentication server 1202 sends terminal device 402 a challenge request. This challenge request includes information (such as a network or provider ID) that user terminal 402 processes to generate a challenge response that is sent to authentication server 1202. This processing may involve selecting a key from service/key database 216 that corresponds to the information in the challenge request.

Terminal device 402 transmits this challenge response to authentication server 1202 via access point 406. Upon receipt, authentication server 1202 compares this response to an expected result. If the challenge response matches the expected result, then authentication server 1202 sends a success message to terminal device 402. This success message indicates that the BNEP connection is authenticated.

The EAP authentication performed in step 1322 may be arranged in a “secure pipe”, where the signaling exchanged during this step is encrypted. This encryption can be performed with transport layer security (TLS). Such techniques are described in a Feb. 23, 2002 Internet Draft entitled “Protected EAP Protocol (PEAP).” This document is incorporated herein by reference in its entirety and may be found on the Internet at http://search.ietf.org/internet-drafts/draft-josefsson-pppext-eap-tls-eap-02.txt. Such techniques are also described in a February, 2002 Internet Draft entitled “EAP Tunneled TLS Authentication Protocol (EAP-TTLS).” This document is incorporated herein by reference in its entirety and may be found on the Internet at http://search.ietf.org/internet-drafts/draft-ietf-pppext-eap-ttls-01.txt.

In implementations where EAP signaling is arranged in such a secure pipe, authentication server 1202 delivers success information to access point 406 in another secure pipe that employs, for example, IPSEC encryption. IPSEC provides a set of protocols developed by the IETF to support secure exchange of packets at the IP layer. If EAP signaling is not arranged in a secure pipe, then success information can be collected by access point 406 from the EAP messages.

After EAP authentication is complete, terminal device 402 is provided with a master key. This may be performed according to various approaches. For instance, one approach involves transmitting a master key to terminal device 402 through a “secure pipe” from access point 406. This approach is illustrated in FIG. 13 and begins with a step 1324, where authentication server 1202 provides the master key to terminal device 402 through a “secure pipe” from access point 406 (which received the master key from authentication server 1202 through a secure pipe employing, for example, IPSEC encryption).

In a step 1326, the master key reaches terminal host 220 within terminal device 402. In a step 1328, terminal host 220 generates the group key from the master key. After the group key is generated, terminal host 220 stores the group key and the association of the network ID in service/key database 216. Thus, the old group key is overwritten. Following this, in a step 1330, terminal host 220 forwards the group key to terminal module (e.g., Bluetooth module) 222.

As an alternative to the technique shown in steps 1324-1328 of FIG. 13, terminal device 402 may use information received from authentication server 1202 to derive the master key. In doing so, it may use techniques, such as those described in a June 2002 Internet Draft entitled “EAP SIM Authentication.” This document is incorporated herein by reference in its entirety and may be found on the Internet at http://search.ietf.org/internet-drafts/draft-haverinen-pppext-eap-sim-05.txt.

This document describes an EAP mechanism for authentication and key distribution using a Subscriber Identity Module (SIM), which is a software application that may be included in terminal device 402. According to this mechanism (referred to herein as EAP SIM), an authentication algorithm that runs on the SIM may be given a 128-bit random number (RAND) as a challenge. The SIM runs an algorithm that processes the RAND and a secret key stored on the SIM as input, and produces a response and a key as outputs.

In embodiments employing such techniques, a master key is not transmitted from authentication server 1202 to terminal device 402. Instead, a master key is merely deduced by terminal device 402 using parameters for EAP authentication as well as material stored in terminal device 402, such as a SIM. Accordingly, in such embodiments, access point 406 does not generate a master key. A master key is always provided to it using some secure channel. Thus, when terminal device 402 generates a master key using received EAP parameters, such as in EAP SIM, then authentication server 1202 does not send the master key to the terminal device 402, only to access point 406.

A step 1332 follows step 1330. In this step, the link (e.g., a Bluetooth link) between access point 406 and terminal device 402 is authenticated based on the link key (i.e., group key) accessed in step 1328. Therefore, this authentication process does not require pairing to be performed. After authentication, steps 1334 is performed. In this step, an encryption key for secure communications is established between terminal device 402 and access point 406.

FIG. 14 shows a sequence of steps involving techniques of the present invention where terminal device 402 establishes a link with access point 406 in a manner that is different from FIG. 13. In particular, FIG. 14 replaces steps 1306, 1308, and 1310 with a step 1402.

In step 1402, terminal device 402 establishes a link with access point 406. However, in contrast to FIG. 10, this link is initiated by terminal device 402. In particular, step 1402 comprises terminal device 402 sending inquiry messages that result in its identification of access point 406. Next, terminal device 402 enters a page state and access point 406 enters a page scan state.

Once this occurs, terminal device 402 pages access point 406. this paging establishes a link between these devices, where terminal device 402 is the master and access point 406 is the slave. Next, a master/slave role switch (MS switch) occurs between these devices so that terminal device 402 is the slave and access point 406 is the master. This role switch may be initiated by either access device 406 or terminal device 402.

After step 1402, steps 1312 through 1334 are performed, as described above with reference to FIG. 13. Also, as described above with reference to FIG. 13, steps 1324-1328 may be substituted with an alternative EAP SIM approach that involves the derivation of a master key.

VII. Multiple Access Zone IDs

The techniques shown in FIGS. 8-14 have been described with in the context of terminal device 402 receiving a particular network or access zone ID. For instance, with reference to FIGS. 9, 10, 11, 13 and 14, steps 906, 1018, and 1318 have been described in the context of terminal device 402 receiving a single network ID.

However, multiple network or provider IDs may be offered to a user terminal. In operational environments, such as the one shown in FIG. 12, this feature allows user terminals to direct the authentication exchange to one of several authentication servers that grant access to a shared infrastructure, such as backbone network 10.

Accordingly, with reference to FIGS. 9, 10, 11, 13 and 14, terminal device 402 may receive multiple network IDs in steps 906, 1018, and 1318. This may be implemented by making the SDP records and the BNEP authentication request messages received in these steps each include a list of access zone IDs. From these lists, the terminal device may choose a network ID to which it is subscribed.

So, in other words, an access point can advertise (and provide) more than one access point zone. Accordingly, in such embodiments, access point zones are not necessarily limited to physical areas, but to available network IDs and/or authentication servers.

VIII. Computer System

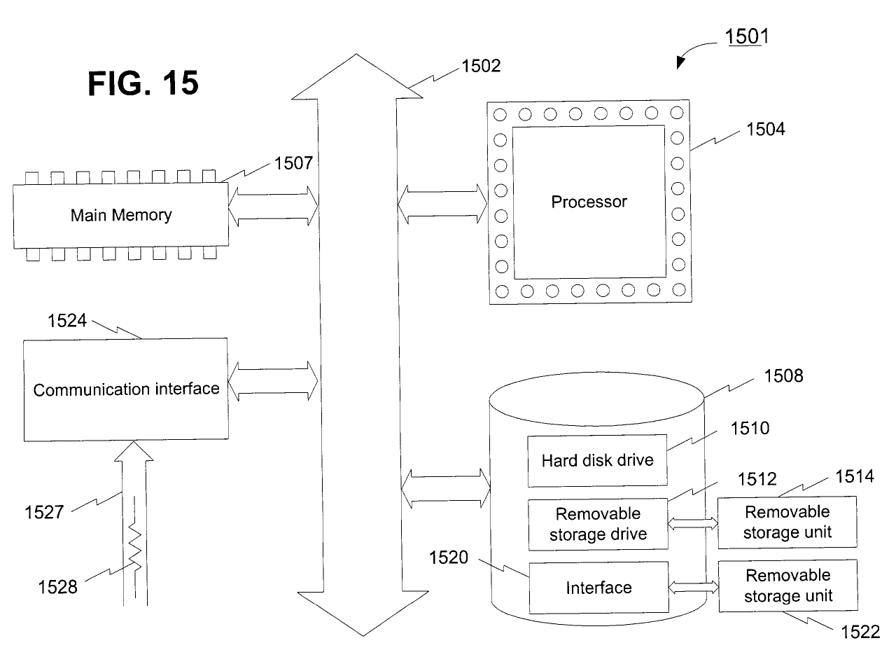

The access point devices, terminal devices, remote servers, and authentication servers described herein may implemented with one or more computer systems. An example of a computer system 1501 is shown in FIG. 15. Computer system 1501 represents any single or multi-processor computer. Single-threaded and multi-threaded computers can be used. Unified or distributed memory systems can be used.

Computer system 1501 includes one or more processors, such as processor 1504. One or more processors 1504 can execute software implementing the process described above with reference to FIGS. 5-11. Each processor 1504 is connected to a communication infrastructure 1502 (for example, a communications bus, cross-bar, or network). Various software embodiments are described in terms of this exemplary computer system. After reading this description, it will become apparent to a person skilled in the relevant art how to implement the invention using other computer systems and/or computer architectures.

Computer system 1501 also includes a main memory 1507 which is preferably random access memory (RAM). Computer system 1501 may also include a secondary memory 1508. Secondary memory 1508 may include, for example, a hard disk drive 1510 and/or a removable storage drive 1512, representing a floppy disk drive, a magnetic tape drive, an optical disk drive, etc. Removable storage drive 1512 reads from and/or writes to a removable storage unit 1514 in a well known manner. Removable storage unit 1514 represents a floppy disk, magnetic tape, optical disk, etc., which is read by and written to by removable storage drive 1512. As will be appreciated, the removable storage unit 1514 includes a computer usable storage medium having stored therein computer software and/or data.

In alternative embodiments, secondary memory 1508 may include other similar means for allowing computer programs or other instructions to be loaded into computer system 1501. Such means can include, for example, a removable storage unit 1522 and an interface 1520. Examples can include a program cartridge and cartridge interface (such as that found in video game devices), a removable memory chip (such as an EPROM, or PROM) and associated socket, and other removable storage units 1522 and interfaces 1520 which allow software and data to be transferred from the removable storage unit 1522 to computer system 1501.

Computer system 1501 may also include a communications interface 1524. Communications interface 1524 allows software and data to be transferred between computer system 1501 and external devices via communications path 1527. Examples of communications interface 1527 include a modem, a network interface (such as Ethernet card), a communications port, etc. Software and data transferred via communications interface 1527 are in the form of signals 1528 which can be electronic, electromagnetic, optical or other signals capable of being received by communications interface 1524, via communications path 1527. Note that communications interface 1524 provides a means by which computer system 1501 can interface to a network such as the Internet.

The present invention can be implemented using software running (that is, executing) in an environment similar to that described above with respect to FIG. 15. In this document, the term “computer program product” is used to generally refer to removable storage units 1514 and 1522, a hard disk installed in hard disk drive 1510, or a signal carrying software over a communication path 1527 (wireless link or cable) to communication interface 1524. A computer useable medium can include magnetic media, optical media, or other recordable media, or media that transmits a carrier wave or other signal. These computer program products are means for providing software to computer system 1501.

Computer programs (also called computer control logic) are stored in main memory 1507 and/or secondary memory 1508. Computer programs can also be received via communications interface 1524. Such computer programs, when executed, enable the computer system 1501 to perform the features of the present invention as discussed herein. In particular, the computer programs, when executed, enable the processor 1504 to perform the features of the present invention. Accordingly, such computer programs represent controllers of the computer system 1501.

The present invention can be implemented as control logic in software, firmware, hardware or any combination thereof. In an embodiment where the invention is implemented using software, the software may be stored in a computer program product and loaded into computer system 1501 using removable storage drive 1512, hard drive 1510, or interface 1520. Alternatively, the computer program product may be downloaded to computer system 1501 over communications path 1527. The control logic (software), when executed by the one or more processors 1504, causes the processor(s) 1504 to perform the functions of the invention as described herein.

In another embodiment, the invention is implemented primarily in firmware and/or hardware using, for example, hardware components such as application specific integrated circuits (ASICs). Implementation of a hardware state machine so as to perform the functions described herein will be apparent to persons skilled in the relevant art(s).

IX. Conclusion

While various embodiments of the present invention have been described above, it should be understood that they have been presented by way of example only, and not limitation. For instance, the present invention is not limited to Bluetooth. Furthermore, the present invention can be applied to previous and future developed Bluetooth standards, as well as variations from such Bluetooth standards.

Moreover, although the processes of FIGS. 8, 9, 10, and 11, 13, and 14 are described with reference to the elements of FIG. 4, these illustrated process may be applied to other scenarios and topologies.

Accordingly, it will be apparent to persons skilled in the relevant art that various changes in form and detail can be made therein without departing from the spirit and scope of the invention. Thus, the breadth and scope of the present invention should not be limited by any of the above-described exemplary embodiments, but should be defined only in accordance with the following claims and their equivalents.

What is claimed is:

1. A method, in a terminal device, of handing over a wireless communications session from a first access point to a second access point, the method comprising:
(a) establishing a link with the second access point;
(b) receiving service description data from the second access point;
(c) selecting a group key based on the service description data; and
(b) authenticating the link with the second access point using the selected group key.

2. The method of claim 1, wherein step (b) comprises receiving a Service Discovery Protocol (SDP) message.

3. The method of claim 1, farther comprising sending to the second access point a request for service description data.

4. The method of claim 1, wherein the service description data corresponds to a zone that includes the second access point.

5. The method of claim 1, wherein the link is a short range radio link.

6. The method of claim 1, wherein the link is a Bluetooth link.

7. The method of claim 1, wherein step (c) comprises:
matching the received service description data with a pre-stored access zone ID; and
selecting a group key that corresponds to the matched access zone ID.

8. The method of claim 1, wherein the service description data received from the second access point indicates an access point zone ID that is the same as an access point zone ID received from the first access point.

9. A terminal device that is capable of handing over a wireless communications session from a first access point to a second access point, the terminal device comprising:
means for establishing a link with the second access point;
means for receiving service description data from the second access point;
means for selecting a group key based on the service description data; and
means for authenticating the link with the second access point using the selected group key.

10. The terminal device of claim 9, wherein said means for receiving service description data comprises means for receiving a Service Discovery Protocol (SDP) message.

11. The terminal device of claim 9, further comprising means for sending to the second access point a request for service description data.

12. The terminal device of claim 9, wherein the service description data corresponds to a zone that includes the second access point.

13. The terminal device of claim 9, wherein the link is a short range radio link.

14. The terminal device of claim 9, wherein the link is a Bluetooth link.

15. The terminal device of claim 9, wherein said means for selecting a group key comprises:
means for matching the received service description data with a pre-stored access zone ID; and
means for selecting a group key that corresponds to the matched access zone ID.

16. The terminal device of claim 9, wherein the service description data received from the second access point indicates an access point zone ID that is the same as an access point zone ID received from the first access point.

17. A method, in a current access point, of handing over a wireless communications session with a terminal device from a previous access point, the method comprising:
(a) establishing a link with the terminal device;
(b) sending service description data to the terminal device; and
(c) authenticating the link with the second access point using a group key based on the service description data.

18. The method of claim 17 wherein the service description data corresponds to a zone that includes the current access point.

19. The method of claim 17, further comprising the step of receiving a handover notification from the previous access point.

20. The method of claim 19, wherein the handover notification includes the terminal device address.

21. The method of claim 17, wherein the link is a short range radio link.

22. The method of claim 17, wherein the link is a Bluetooth link.

23. An access point that is capable of handing over a wireless communications session with a terminal device from a previous access point, the access point comprising:
means for establishing a link with the terminal device;
means for sending service description data to the terminal device; and
means for authenticating the link with the second access point using a group key based on the service description data.

24. The access point of claim 23 wherein the service description data corresponds to a zone that includes the current access point.

25. The access point of claim 23, further comprising means for receiving a handover notification from the previous access point.

26. The access point of claim 25, wherein the handover notification includes the terminal device address.

27. The access point of claim 23 wherein the link is a short range radio link.

28. The access point of claim 23, wherein the link is a Bluetooth link.

29. A method, in a terminal device, of handing over a wireless communications session from a first access point to a second access point, the method comprising:
(a) entering a first coverage area associated with the first access point;
(b) establishing a first link with the first access point
(c) receiving service description data from the first access point;
(d) selecting a first group key based on the service description data from the first access point;
(e) authenticating the first link using the first group key;
(f) establishing a communications session with the first access point;
(g) entering a second coverage area associated with the second access point;
(h) establishing a second link with the second access point;
(i) receiving service description data from the second access point;
(j) selecting a second group key based on the service description data from the second access point;
(k) authenticating the second link using the second group key; and
(l) continuing the communications session with the second access point.

30. The method of claim 29, wherein step (d) comprises:
matching the service description data received from the first access point with a prestored access zone ID; and
selecting a group key that corresponds to the matched access zone ID.

31. The method of claim 29, wherein step (j) comprises:
matching the service description data received from the second access point with a pre-stored access zone ID; and
selecting a group key that corresponds to the matched access zone ID.

32. The method of claim 29, wherein the service description data received from the second access point indicates an access point zone ID that is the same as an access point zone ID indicated by the service description data received from the first access point.

33. The method of claim 29, wherein the first and second group keys are the same.

34. A terminal device that is capable of handing over a wireless communications session from a first access point to a second access point, the terminal device comprising:
means for entering a first coverage area associated with the first access point;
means for establishing a first link with the first access point
means for receiving service description data from the first access point;
means for selecting a first group key based on the service description data from the first access point;
means for authenticating the first link using the first group key;
means for establishing a communications session with the first access point;
means for entering a second coverage area associated with the second access point;
means for establishing a second link with the second access point;
means for receiving service description data from the second access point;
means for selecting a second group key based on the service description data from the second access point;
means for authenticating the second link using the second group key; and
means for continuing the communications session with the second access point.

35. The terminal device of claim 34, wherein said means for selecting a first group key based on the service description data from the first access point comprises:
means for matching the service description data received from the first access point with a pre-stored access zone ID; and
means for selecting a group key that corresponds to the matched access zone ID.

36. The terminal device of claim 34, wherein said means for selecting a second group key based on the service description data from the second access point comprises:
means for matching the service description data received from the second access point with a pre-stored access zone ID; and
means for selecting a group key that corresponds to the matched access zone ID.

37. The terminal device of claim 34, wherein the service description data received from the second access point indicates an access point zone ID that is the same as an access point zone ID indicated by the service description data received from the first access point.

38. The terminal device of claim 34, wherein the first and second group keys are the same.

39. A computer program product comprising a computer useable medium having computer program logic recorded thereon for enabling a processor in a computer system of a terminal device to hand over a wireless communications session from a first access point to a second access point, the computer program logic comprising:
program code for enabling the processor to establish a link with the second access point;
program code for enabling the processor to receive service description data from the second access point;
program code for enabling the processor to select a group key based on the service description data; and program code for enabling the processor to authenticate the link with the second access point using the selected group key.

40. A computer program product comprising a computer useable medium having computer program logic recorded thereon for enabling a processor in a computer system of an access point to hand over a wireless communications session with a terminal device from a previous access point, the computer program logic comprising:
program code for enabling the processor to establish a link with the terminal device;
program code for enabling the processor to send service description data to the terminal device; and
program code for enabling the processor to authenticate the link with the second access point using a group key based on the service description data.
